(19) United States
(12) Patent Application Publication
(10) Pub. No.: US 2015/0093737 A1
(43) Pub. Date: Apr. 2, 2015

(54) APPARATUS AND METHOD FOR AUTOMATIC SCORING

(71) Applicant: SK TELECOM CO., LTD., Seoul (KR)

(72) Inventors: Jongcheol YUN, Guri-si (KR); Kyunga YOON, Seoul (KR)

(21) Appl. No.: 14/558,154

(22) Filed: Dec. 2, 2014

Related U.S. Application Data
(63) Continuation of application No. PCT/KR2013/005347, filed on Jun. 18, 2013.

(30) Foreign Application Priority Data
Oct. 31, 2012 (KR) 10-2012-0122380

(51) Int. Cl. G09B 7/00; G06N 99/00

(52) U.S. Cl. CPC G09B 7/00; G06N 99/005
USPC 434/353

(57) ABSTRACT

An automatic scoring apparatus includes: an automatic scoring unit to receive scoring target data, apply a corresponding scoring model per each of evaluation regions, and automatically calculate a score per each of the evaluation regions with respect to the received scoring target data based on the applied corresponding scoring model; and a score tuning unit to tune the calculated score per each of the evaluation regions using a corresponding correlation model between the evaluation regions.

### CROSS REFERENCE TO RELATED APPLICATIONS

The instant application is continuation of PCT/KR2013/005347, filed Jun. 18, 2013, which is based on and claims priority of Korean Patent Application No. 10-2012-0122380, filed on Oct. 31, 2012, in the KIPO (Korean Intellectual Property Office). The disclosures of above-listed applications are hereby incorporated by reference herein in their entirety.

### TECHNICAL FIELD

The present disclosure relates to automatic scoring technology of automatically scoring a user's answers through machine learning, and more particularly, to an automatic scoring apparatus and method of automatically scoring target data by considering a correlation between evaluation regions.

### BACKGROUND

Descriptions in this section merely provide background information about the present disclosure, but do not constitute prior art.

According to developments of communication technology, a language test and a simple level test, etc. are performed using the communication technology, and for this, a server apparatus provides the test and a scoring result by scoring answers of the test. The inventor(s) has noted that a scheme in which a person directly scores the test to score the answers of the test and the person inputs scoring data to the server apparatus, etc. in order to provide the scoring result is used.

However, the inventor(s) has noted that this kind of the scoring scheme requires a lot of labors to score the answers of the test and a considerable amount of time to confirm the scoring result.

The inventor(s) has also noted that an automatic scoring system for automatically scoring the answers of the test through the machine learning, not by a human being, is being developed. The inventor(s) has noted that the known automatic scoring system performs an automatic scoring by collecting examiner's subjective scoring result with respect to a plurality of answers of tests, analyzing evaluable items (evaluation qualities) through the machine learning in the answers of the tests, generating a scoring model based on the evaluable items through the machine learning using the analyzed result and the examiner's subjective scoring result, and analyzing similarity of the answers of the tests through the generated scoring model.

The inventor(s) has experienced that according to language educational characteristics, there are characteristics in that the scoring regions are not completely mutually exclusive and the score of each of the examiner's evaluation regions mutually affects. The inventor(s) has noted that the known automatic scoring system does not reflect the characteristics, and the reliability of the automatic scoring scheme performed by the known automatic scoring system is considered low in view of the examiner's scoring result and accuracy.

### SUMMARY

In accordance with some embodiments, an automatic scoring apparatus, comprises an automatic scoring unit and a score tuning unit. The automatic scoring unit is configured to receive scoring target data, apply a corresponding scoring model per each of evaluation regions, and automatically calculate a score per each of the evaluation regions with respect to the received scoring target data based on the applied corresponding scoring model. And the score tuning unit is configured to tune the calculated score per each of the evaluation regions using a corresponding correlation model between the evaluation regions.

In accordance with some embodiments, an automatic scoring apparatus is configured to receive scoring target data, apply a corresponding scoring model per each of evaluation regions, automatically calculate a score per each of one or more evaluation regions with respect to the received scoring target data based on the applied corresponding scoring model, and tune the calculated score per each of the evaluation regions using a corresponding correlation model between the evaluation regions.

In accordance with some embodiments, a non-transitory computer-readable recording medium is configured to record a program for executing an automatic scoring method performed by an automatic scoring apparatus. The method comprises receiving scoring target data; applying a corresponding scoring model per each of evaluation regions; automatically calculating a score per each of one or more evaluation regions with respect to the received scoring target data based on the applied corresponding scoring model; and tuning the calculated score per each of the evaluation regions using a corresponding correlation model between the evaluation regions.

### BRIEF DESCRIPTION OF DRAWINGS

FIG. 1 is a diagram of a construction of an automatic scoring apparatus according to an exemplary embodiment of the present disclosure;

FIG. 2 is a diagram for describing a method of performing an automatic scoring operation applying a correlation model between evaluation regions according to an exemplary embodiment of the present disclosure;

FIG. 3 is a diagram of a construction of an automatic evaluation service system to which an automatic scoring apparatus is applied according to an exemplary embodiment of the present disclosure;

FIG. 4 is a diagram of a terminal device to which an automatic scoring method is applied according to an exemplary embodiment of the present disclosure;

FIGS. 5A to 5C are correlation tables between evaluation regions for describing a correlation model between the evaluation regions according to an exemplary embodiment of the present disclosure; and

FIGS. 6 to 8 are diagrams for describing an automatic scoring operation applying a correlation model between evaluation regions according to an exemplary embodiment of the present disclosure.

### DETAILED DESCRIPTION

Hereinafter, embodiments of the present disclosure will be described below in more detail with reference to the accompanying drawings. A detailed description of known functions or configurations in the following descriptions and accompanying drawings will be omitted. Further, throughout the drawings, it will be understood that the same or similar elements are designated by like reference numerals.

Exemplary embodiments of the present disclosure provide an automatic scoring apparatus and method to automatically score scoring target data by considering a correlation between evaluation regions when automatically scoring the scoring target data including a user's answers using machine learning. Further, exemplary embodiments of the present disclosure provide automatic scoring apparatus and method which compensate an error in a scoring model of each of evaluation regions by generating a correlation model between the evaluation regions reflecting language educational characteristics, evaluation region characteristics, an examiner's answer evaluation characteristics, etc., and by applying the generated correlation model.

The present disclosure relates to technology of automatically evaluating the answers of the user in one or more language regions including speaking, listening, writing, etc. More particularly, when evaluating the one or more evaluation regions with respect to the answers of the user, exemplary embodiments of the present disclosure provide more realistically model of an implicit criterion with respect to the evaluation regions by generating the correlation model between the evaluation regions reflecting the language educational characteristics, the evaluation region characteristics, the examiner's answer evaluation characteristics, etc. Further, exemplary embodiments of the present disclosure select the abnormal evaluation region in which the correlation disparity between the evaluation regions is beyond the predetermined range, and tune the score of the abnormal evaluation region as the score having the highest generation probability based on the automatic scoring scores of the remaining evaluation regions. Accordingly, since the scoring is performed to be more similar to the examiner's subjective scoring data, some embodiments of the present disclosure can improve the automatic evaluation performance. Exemplary embodiments of the present disclosure are applied to the automatic scoring service, perform the automatic scoring operation to be more similar to the examiner's subjective scoring data considering the correlation between the evaluation regions, and contribute to developments of service industry.

Based on a principle in which the terminology and vocabulary used below to describe the specification and claims should not be construed as general or dictionary meanings, and are defined as concepts of the terminology to describe the disclosure in the best way, the terminology and vocabulary should be interpreted as the meanings and the concepts correspond to a technical spirit of the disclosure. Accordingly, constructions shown the embodiments and drawings described in the specification are merely the exemplary embodiments, and since the constructions do not show all the technical spirit of the present disclosure, it will be understood that there are various equivalents and modifications capable of replacing them.

In the following description, “evaluation regions” are a scoring criterion set for standardizing scores between examiners with respect to a specific evaluation test, and are defined as scoring regions and evaluation contents of the scoring regions. For example, in a speaking test of a foreign language, the evaluation regions (or evaluation factors) include the scoring regions such as fluency, language use, configurability, and pronunciation. Here, the fluency is a factor of evaluating adequacy of a speaking speed, and a degree of maintaining a natural speaking speed without hesitation. The language use is a factor of evaluating precision of expression and adequacy of vocabulary use. The configurability is a factor of evaluating logical connectivity of speaking and consistency and cohesion of speaking contents. The pronunciation is a factor of evaluating clarity and an understandable degree of the pronunciation. The present disclosure includes some embodiments that implement automatic scoring apparatus and method with respect to one or more predetermined evaluation regions.

First, automatic scoring apparatus and method according to an exemplary embodiment of the present disclosure will be described in detail with reference to the accompanying drawings.

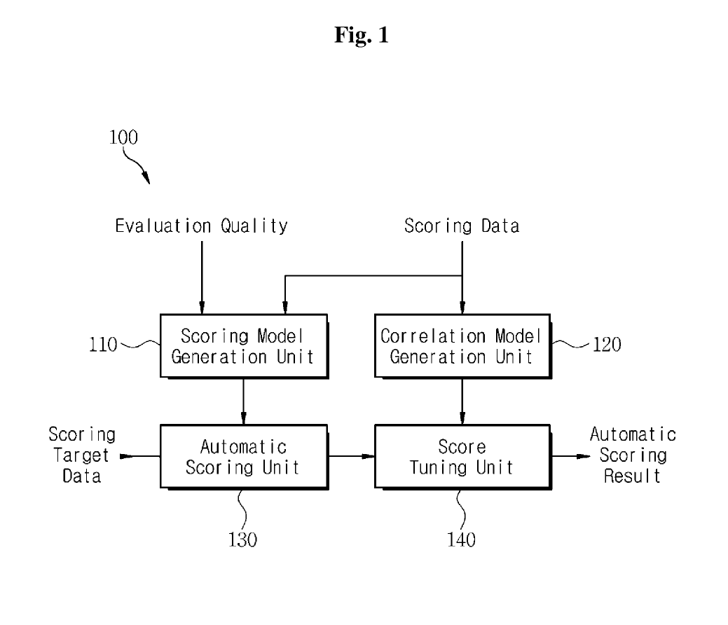

FIG. 1 is a diagram of a construction of an automatic scoring apparatus according to an exemplary embodiment of the present disclosure.

Referring to FIG. 1, an automatic scoring apparatus 100 according to an exemplary embodiment of the present disclosure is an apparatus for automatically scoring answers of an examinee with respect to a specific question based on the one or more predetermined evaluation regions according to the present disclosure. Specifically, the automatic scoring apparatus 100 automatically calculates a score of each of the one or more one predetermined evaluation regions with respect to scoring target data using a scoring model of each of the one or more predetermined evaluation regions. Next, the automatic scoring apparatus 100 compares the automatic scoring score of each of the evaluation regions scored by the scoring model of each of the evaluation regions using a correlation model between previously generated evaluation regions, and tune an automatic scoring score of an abnormal evaluation region having a score beyond a predetermined range.

For this, the automatic scoring apparatus 100 collects scoring data used as a criterion with respect to one or more answers of tests, for example, scoring data with respect to one or more evaluation regions which are directly scored by an examiner. Further, the automatic scoring apparatus 100 extracts one or more evaluation qualities from the one or more answers of tests. Moreover, the automatic scoring apparatus 100 generates a scoring model of each of the evaluation regions by performing machine learning using the evaluation qualities extracted from each of the one or more answers of tests and the previous scoring data.

The automatic scoring apparatus 100 automatically calculates a score of each of the evaluation regions with respect to scoring target data which is newly input through the scoring model of each of the generated evaluation regions.

Moreover, the automatic scoring apparatus 100 previously generates a correlation model between the evaluation regions using the scoring data.

The automatic scoring apparatus 100 includes a scoring model generation unit 110, a correlation model generation unit 120, an automatic scoring unit 130, and a score tuning unit 140. The scoring model generation unit 110, the correlation model generation unit 120, the automatic scoring unit 130, and the score tuning unit 140 is implemented by hardware, software, or a combination of the hardware and software. For example, the scoring model generation unit 110, the correlation model generation unit 120, the automatic scoring unit 130, and the score tuning unit 140 is implemented by a combination of software implemented to perform functions which will be described below and a microprocessor executing the software. All or some components of the automatic scoring apparatus 100, such as the scoring model generation unit 110, the correlation model generation unit 120, the automatic scoring unit 130, and the score tuning unit 140 are implemented by one or more processors and/or application-specific integrated circuits (ASICs).

The scoring model generation unit 110 generates the scoring model of each of the evaluation regions through the scoring data of each of the evaluation regions with respect to the one or more answers of tests previously scored by the examiner and the machine learning using the one or more evaluation qualities extracted from the one or more answers of tests previously scored by the examiner.

Specifically, the scoring model generation unit 110 receives the evaluation qualities, that is, an automatically evaluable items (for example, the number of words, the number of adjectives, grammatical errors, spelling errors, tense discrepancies, similarity with a model answer, etc.), extracted from the one or more answers of tests. Further, the scoring model of each of the evaluation regions defining a relation between the evaluation qualities and the score of each of the evaluation regions is generated by performing the machine learning with respect to the evaluation qualities and the scoring data of each of the evaluation regions of the examiner with respect to the one or more answers of tests. That is, the examiner's subjective evaluation criterion is modeled based on the one or more automatically evaluable evaluation qualities.

The correlation model generation unit 120 models a correlation between the evaluation regions in the scoring data that the examiner scores by reflecting the language educational characteristics, the evaluation region characteristics, the examiner's answer evaluation characteristics, etc. For this, the correlation model generation unit 120 analyzes the correlation between the evaluation regions using the one or more previous scoring data used for generating the scoring model of each of the evaluation regions, and generate a correlation model.

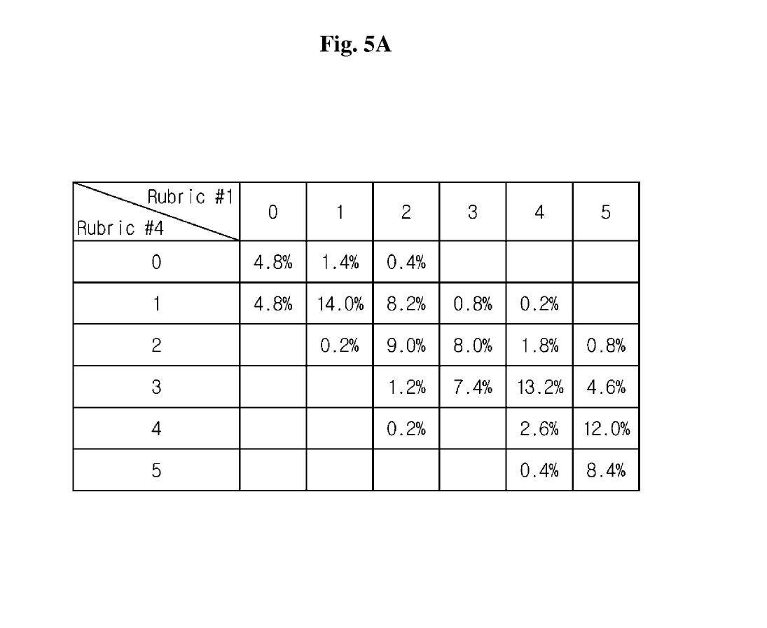

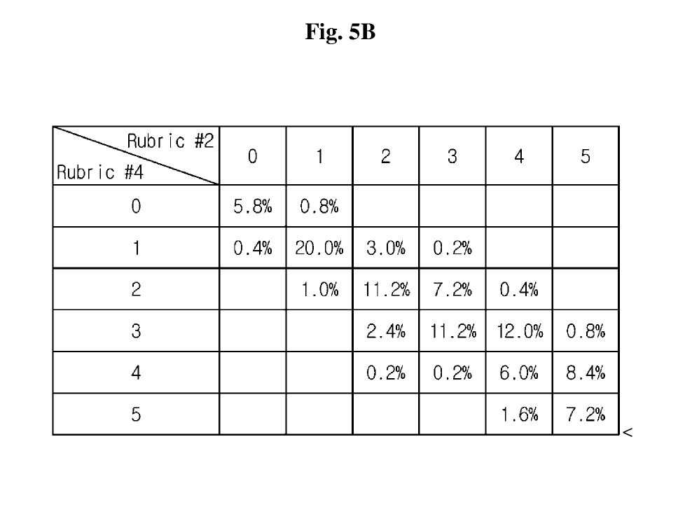

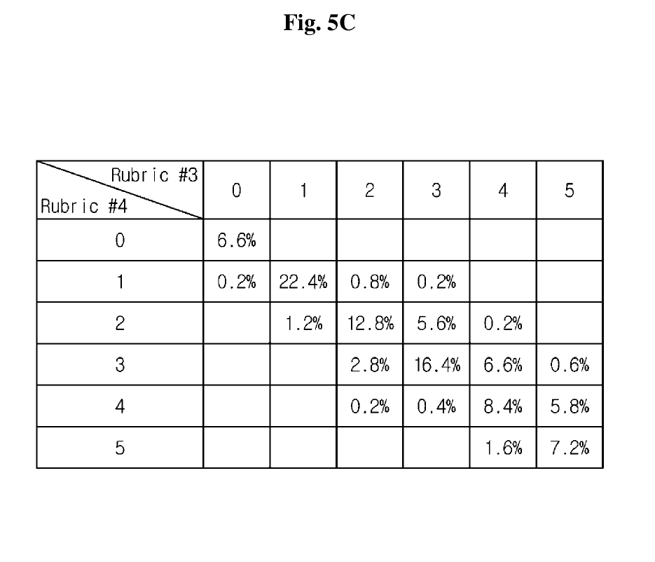

For example, the correlation model generation unit 120 defines characteristics affecting the scores between the evaluation regions as a generation probability table of each of the scores between the evaluation regions as shown in FIGS. 5A to 5C. In an embodiment, when first to fourth evaluation regions are set and scores ranging from 0 to 5 are scored in each of the evaluation regions, the generation probability table is generated by analyzing correlations between the fourth evaluation region (Rubric #4) which is a criterion and other evaluation regions (Rubrics #1, #2, and #3). Specifically, FIG. 5A is a generation probability table illustrating a correlation between the first evaluation region (Rubric #1) and the fourth evaluation region (Rubric #4) as a generation probability of each of the scores, FIG. 5B is a generation probability table illustrating a correlation between the second evaluation region (Rubric #2) and the fourth evaluation region (Rubric #4) as a generation probability of each of the scores, and FIG. 5C is a generation probability table illustrating a correlation between the third evaluation region (Rubric #3) and the fourth evaluation region (Rubric #4) as a generation probability of each of the scores.

The generation probability of scores between the evaluation regions is obtained using the correlation model. For example, with reference to FIG. 5C, when a score of the third evaluation region (Rubric #3) is 3, a probability in which a score of the fourth evaluation region (Rubric #4) is 0 is 0%, a probability in which the score of the fourth evaluation region (Rubric #4) is 1 is 0.2%, a probability in which the score of the fourth evaluation region (Rubric #4) is 2 is 5.6%, a probability in which the score of the fourth evaluation region (Rubric #4) is 3 is 16.4%, a probability in which the score of the fourth evaluation region (Rubric #4) is 4 is 0.4%, and a probability in which the score of the fourth evaluation region (Rubric #4) is 5 is 0%. Accordingly, when the score of the third evaluation region (Rubric #3) is 3, the possibility in which the score of the fourth evaluation region (Rubric #4) is 3 or 2 is very high. Further, when the score of the fourth evaluation region (Rubric #4) is 3, a probability in which the score of the third evaluation region (Rubric #3) is 0 or 1 is 0%, a probability in which the score of the third evaluation region (Rubric #3) is 2 is 2.8%, a probability in which the score of the third evaluation region (Rubric #3) is 3 is 16.4%, a probability in which the score of the third evaluation region (Rubric #3) is 4 is 6.6%, and a probability in which the score of the third evaluation region (Rubric #3) is 5 is 0.6%. Through the correlation model between the evaluation regions, it can be seen that the answers of the test having a high score in the third evaluation region (Rubric #3) have a high probability of having a high score also in the fourth evaluation region (Rubric #4), and the answers of the test having a low score in the third evaluation region (Rubric #3) have a high probability of having a low score in the fourth evaluation region (Rubric #4). This is because the one or more evaluation regions with respect to a specific answer are not independent of each other and are connected in a linguistic education.

The automatic scoring unit 130 receives a new scoring target data which is the answers of the test for scoring from the examinee, and automatically calculate the score of each of the one or more evaluation regions with respect to the scoring target data using the scoring model of each of the evaluation regions generated in the scoring model generation unit 110.

Next, the score tuning unit 140 tunes the automatic scoring score of each of the evaluation regions with respect to the scoring target data output from the automatic scoring unit 130 through the correlation model between the evaluation regions generated in the correlation model generation unit 120. Specifically, the score tuning unit 140 compares the automatic scoring score of each of the evaluation regions, select an abnormal evaluation region in which a correlation disparity has a greater score than a predetermined range, and adjust the automatic scoring score of the abnormal evaluation region based on the correlation model between the selected abnormal evaluation region and remaining evaluation regions.

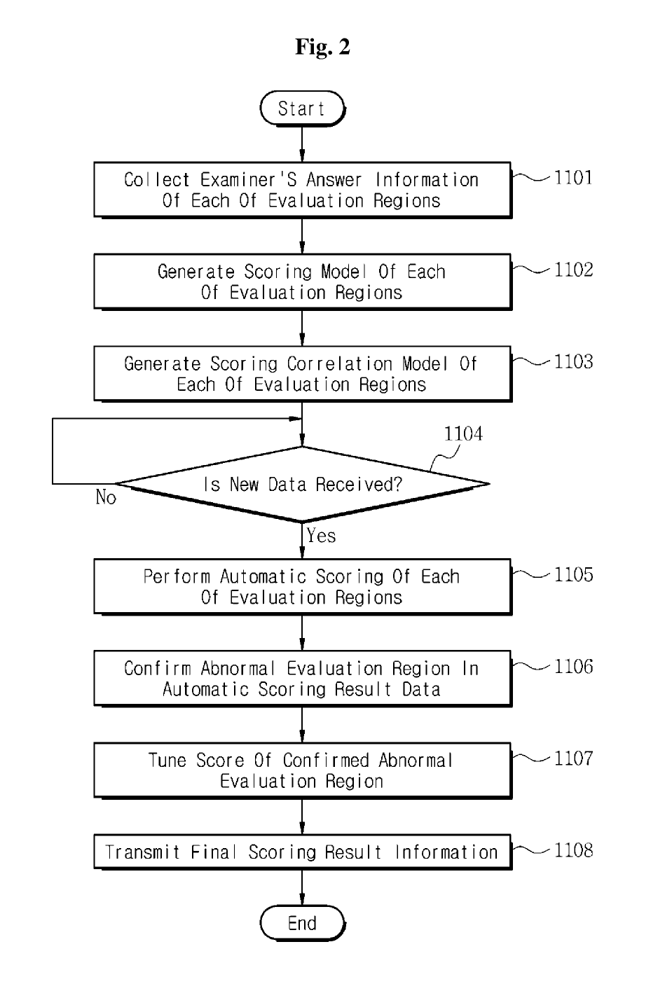

An automatic scoring method according to an embodiment of the present disclosure performed in the automatic scoring apparatus having the construction described above will be described in detail with reference to FIG. 2.

FIG. 2 is a diagram for describing a method of performing an automatic scoring operation applying a correlation model between evaluation regions in an automatic evaluation service system according to an exemplary embodiment of the present disclosure.

Referring to FIG. 2, the automatic scoring apparatus 100 according to an exemplary embodiment of the present disclosure collects the one or more scoring data which are previously scored by examiners in step 1101. The one or more scoring data includes information in which each of one or more examiners score the one or more answers of tests with respect to the one or more evaluation regions.

Next, the automatic scoring apparatus 100 generates the scoring model of each of the evaluation regions through the machine learning based on the collected one or more scoring data in step 1102. More specifically, the automatic scoring apparatus 100 analyzes the automatically evaluable evaluation qualities (for example, the number of words, the number of adjectives, grammatical errors, spelling errors, tense discrepancies, similarity with a model answer, etc.) from the answers of the tests corresponding to the previous scoring data of each of the evaluation regions. The automatic scoring apparatus 100 generates the scoring model of each of the evaluation regions which calculates the score of each of the evaluation regions based on the evaluable evaluation qualities by performing the machine learning on each of the evaluation regions of the analyzed evaluation qualities and the one or more scoring data.

Further, the automatic scoring apparatus 100 generates a correlation model between the evaluation regions as shown in FIGS. 5A to 5C based on the collected scoring data of each of the evaluation regions in step 1103. The correlation model between the evaluation regions is a model of structuralizing a correlation between two evaluation regions. For example, when there are four evaluation regions, six correlation models are generated. Here, the correlation models between the evaluation regions are implemented as a type defining a generation probability of each of scores between two evaluation regions.

Next, the automatic scoring apparatus 100 newly receives scoring target data in which the examinee answers with respect to a specific question in step 1104.

When the new scoring target data is input, the automatic scoring apparatus 100 applies the generated scoring model of each of the evaluation regions, and calculate an automatic scoring score of each of the one or more of evaluation regions with respect to the scoring target data in step 1105. Specifically, the automatic scoring apparatus 100 extracts the one or more evaluation qualities from the new scoring target data, applies the extracted evaluation qualities to the scoring model of each of the evaluation regions, and calculates the automatic scoring score of each of the evaluation regions.

Since the correlation between evaluation regions is not reflected in the calculated automatic scoring score of each of the evaluation regions, the calculated automatic scoring score of each of the evaluation regions has an error. Therefore, the present disclosure further performs an operation of tuning the automatic scoring result using the correlation model described hereinafter.

Specifically, the automatic scoring apparatus 100 compares the automatic scoring score of each of the evaluation regions calculated by the automatic scoring operation, and select the abnormal evaluation region having a score in which the correlation disparity is beyond a predetermined range in step 1106. Here, the correlation disparity is defined as a difference of the scores of two evaluation regions or a probability in which the automatic scoring scores of the two evaluation regions are simultaneously generated.

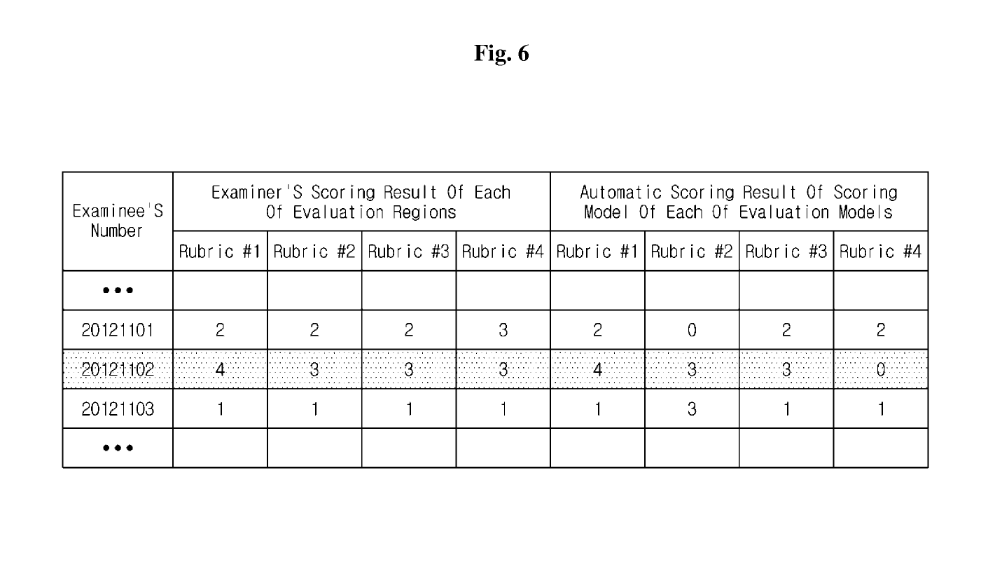

FIG. 6 is a table for describing an automatic scoring method according to an exemplary embodiment of the present disclosure, an examinee's number is information identifying each of examinees, an examiner's subjective scoring result with respect to answers of test of each of the examinees is illustrated in the left side of the table, and an automatic scoring score calculated using the scoring model of each of the evaluation regions with respect to the same answers of test is illustrated in the right side of the table. Here, the scoring is performed on four evaluation regions (Rubrics #1 to #4).

For example, when scoring the answers of the examinee having the examinee's number “20121102” using the scoring model of each of the evaluation regions, the score of the first evaluation region (Rubric #1) is 5, the score of the second evaluation region (Rubric #2) is 3, the score of the third evaluation region (Rubric #3) is 3, and the score of the fourth evaluation region (Rubric #4) is 0. In this case, when selecting the abnormal evaluation region having a score in which the correlation disparity is beyond the predetermined range in step 1106, since the score of the fourth evaluation region (Rubric #4) of the automatic scoring result is 0 and has a great difference compared to the score of each of other evaluation regions, the fourth evaluation region (Rubric #4) is selected as abnormal evaluation region. Here, the abnormal evaluation region is selected by a difference between an average value of the automatic scoring scores of the remaining evaluation regions and its own automatic scoring score, with respect to each of the evaluation regions. That is, the abnormal evaluation region is an evaluation region in which the score of each of the evaluation regions has a difference beyond the predetermined reference value compared to the average value of the automatic scoring scores of the remaining evaluation regions. Here, a selection criterion 6 of the abnormal evaluation region is arbitrarily determined.

Next, the automatic scoring apparatus 100 tunes the automatic scoring score of the selected abnormal evaluation region selected by applying the correlation model between the evaluation regions in step 1107. Specifically, the automatic scoring apparatus 100 confirms the automatic scoring score of the selected abnormal evaluation region and the automatic scoring scores of the remaining evaluation regions, and calculate a generation probability of each of scores (for example, 0 to 5) of the abnormal evaluation region based on the automatic scoring scores of the remaining evaluation regions through the correlation model. Next, the automatic scoring apparatus 100 obtains sums of the probabilities in which the automatic scoring scores of the remaining evaluation regions are generated with respect to each of the scores of the selected abnormal evaluation region, and extract a score in which the sum of the probabilities is the highest. Further, the automatic scoring apparatus 100 tunes the score by changing the automatic scoring score of the selected abnormal evaluation region as the score having the highest probability.

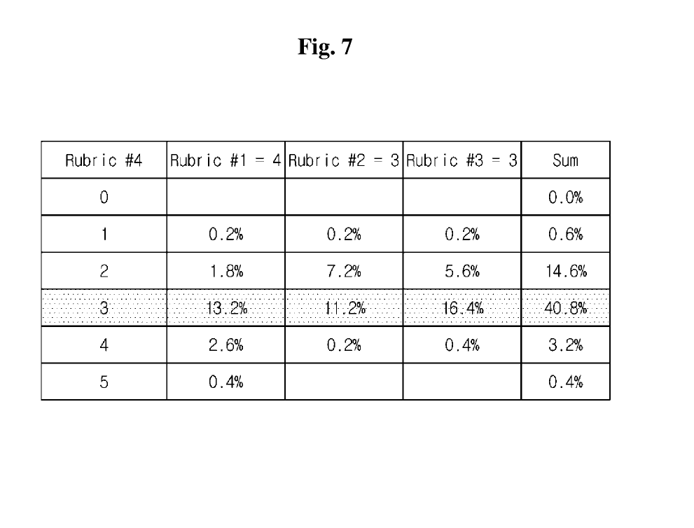

Referring to FIG. 6, from the automatic scoring result of the examinee having the examinee's number “20121102”, the fourth evaluation region is selected as the abnormal evaluation region. At this time, the automatic scoring scores of the remaining evaluation regions are 4, 3, and 3, respectively. In this case, as shown in FIG. 7, the automatic scoring apparatus 100 confirms the generation probability of each of scores (0 to 5) of the fourth evaluation region when the score of the first evaluation region is 4, the generation probability of each of scores (0 to 5) of the fourth evaluation region when the score of the second evaluation region is 3, and the generation probability of each of scores (0 to 5) of the fourth evaluation region when the score of the third evaluation region is 3. Next, the automatic scoring apparatus 100 obtains sums of probabilities in which the automatic scoring scores of the remaining first, second, and third evaluation regions are generated, and extract the score of the fourth evaluation region in which the sum of probabilities is the highest. With reference to FIG. 7, when the automatic scoring scores of the first to third evaluation regions (Rubrics #1 to #3) are 4, 3, and 3, respectively, the generation probability of 3 among the scores of the fourth evaluation region (Rubric #4) is 40.8% in which the sum of probabilities is the highest.

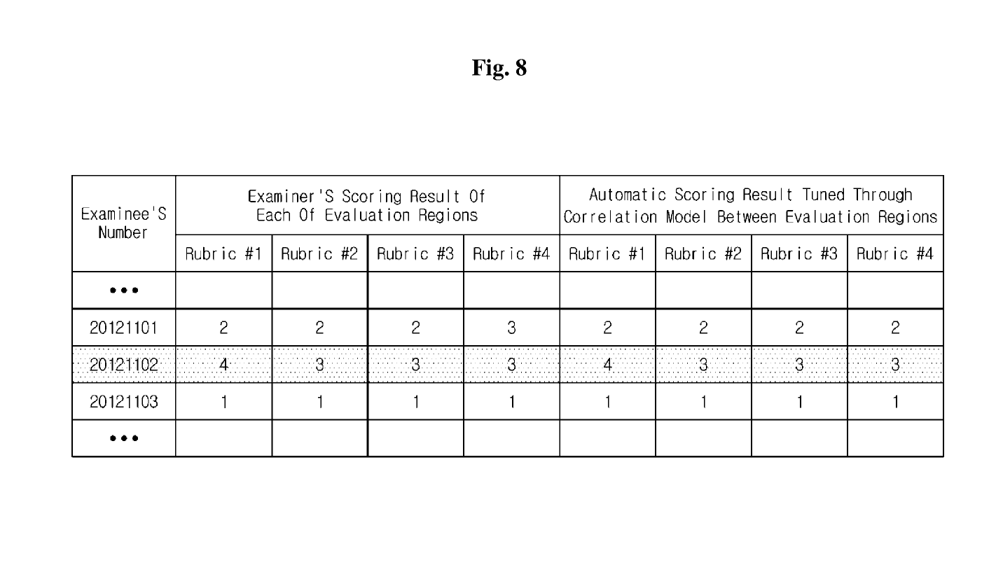

Accordingly, as shown in FIG. 8, the automatic scoring apparatus 100 changes the automatic scoring score of the fourth evaluation region selected as the abnormal evaluation region from 0 to 3.

Further, as shown in FIG. 8, it will be seen that a final automatic scoring result is similarly adjusted to the scoring result scored by the examiner in the automatic scoring apparatus 100.

Next, in step 1108, the automatic scoring apparatus 100 calculates the final automatic scoring result data by tuning the score, and provide final automatic scoring result information corresponding to the calculated final automatic scoring result data for the examinee.

The automatic scoring apparatus and method according to an exemplary embodiment of the present disclosure is applied to a network-based automatic evaluation service system.

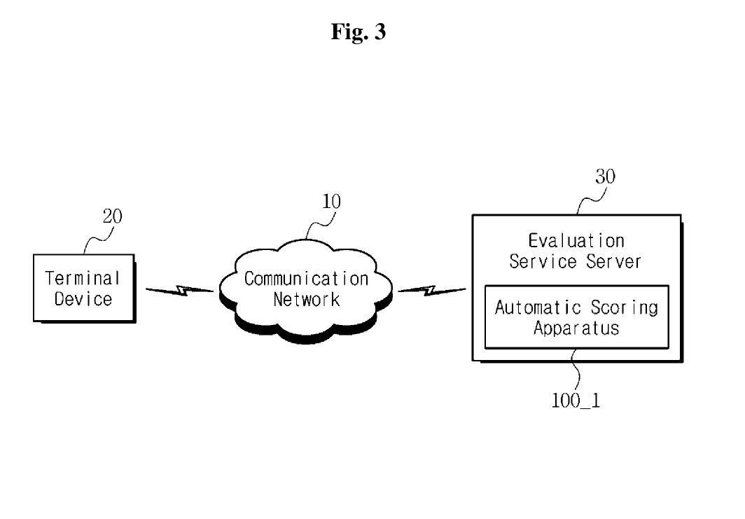

FIG. 3 is a diagram of a construction of an automatic evaluation service system to which an automatic scoring apparatus is applied according to an exemplary embodiment of the present disclosure.

Referring to FIG. 3, the automatic evaluation service system includes a plurality of terminal devices 20 and an evaluation service server 30 including an automatic scoring apparatus 100_1 which are connected through a communication network 10.

Each of the plurality of terminal devices 20 is terminal device capable of receiving and transmitting various data through the communication network 10 according to a key operation of a user, and is at least one among a tablet personal computer (PC), a laptop computer, a PC, a smart phone, a personal digital assistant (PDA), a smart television (TV), a mobile communication terminal, etc. Further, each of the plurality of the terminal devices 20 is a terminal of performing voice or data communication through the communication network 10, and is a terminal including a browser for communicating with the evaluation service server 30 through the communication network 10, a memory for storing a program and a protocol, a microprocessor for calculating and controlling by executing various programs, etc. That is, each of the plurality of the terminal devices 20 is any kinds of terminal capable of performing server-client communication with the evaluation service server 30, and is defined as a terminal of a broad concept including every communication computing device such as a notebook computer, a mobile communication terminal, PDA, etc. Meanwhile, each of the plurality of the terminal devices 20 is manufactured in a type including a touch screen, but each of the plurality of the terminal devices 20 is not limited thereto.

Specifically, each of the plurality of the plurality of terminal devices 20 is a terminal of being provided with an automatic scoring service, and is an examinee's terminal device or an examiner's terminal device. The plurality of terminal devices 20 are connected to the evaluation service server 30 through the communication network 10, receive the answers of the test from the examinee, transmit the answers of the test to the evaluation service server 30, and receive an automatic evaluation result with respect to the answers of the test from the evaluation service server 30. Particularly, the plurality of terminal devices 20 are provided with the scoring result data which are automatically scored by applying the correlation model of each of the evaluation regions from the evaluation service server 30, and provide the scoring result data for a user.

The evaluation service server 30 is a server device for performing the automatic evaluation operation on the answers of the test transmitted from the terminal device 20 and providing the evaluation result, and includes the automatic scoring apparatus 100_1 applying the correlation model according to an exemplary embodiment of the present disclosure.

The automatic scoring apparatus 100_1 provides the automatic scoring service by being connected to the plurality of terminal devices 20 through the communication network 10. The automatic scoring apparatus 100_1 collects scoring data of each of the evaluation regions from the examiner, and store the collected scoring data of each of the evaluation regions to a database. At this time, the scoring data and the evaluation data of each of the evaluation regions are directly input from the examiner, or be transmitted through the communication network 10.

Further, the automatic scoring apparatus 100_1 generates the scoring model of each of the evaluation regions through the machine learning using the collected scoring data of each of the evaluation regions and the evaluation qualities, and also generate the correlation model between the evaluation regions by comparing the scoring results of the evaluation regions and reflecting the language educational characteristics, the evaluation region characteristics, the examiner's answer evaluation characteristics, etc. Further, when receiving new scoring target data from the terminal device 20, the automatic scoring apparatus 100_1 extracts the evaluation qualities from the new scoring target data. The automatic scoring apparatus 100_1 inputs the extracted evaluation qualities to the generated scoring model of each of the evaluation regions, and calculate the automatic scoring score of each of the evaluation regions with respect to the new scoring target data. Next, the automatic scoring apparatus 100_1 applies the generated correlation model between the evaluation regions, and select the abnormal evaluation region in which the correlation disparity has a greater score than the predetermined reference value. The abnormal scoring apparatus 100_1 calculates the generation probability of each of scores of the abnormal evaluation region using the correlation model based on the automatic scoring scores of the remaining evaluation regions excluding the selected abnormal evaluation region, compare the generation probability of each of the scores, and apply the score having the highest probability as the automatic scoring score of the selected abnormal evaluation region. The automatic scoring apparatus 100_1 provides the calculated final automatic scoring score for a corresponding terminal device among the plurality of the terminal devices 20. Since a detailed construction of the automatic scoring apparatus 100_1 was described with reference to FIGS. 1 and 2, repetitive descriptions will be omitted.

The automatic scoring method according to an exemplary embodiment of the present disclosure is used by implementing as a program installed on the terminal device.

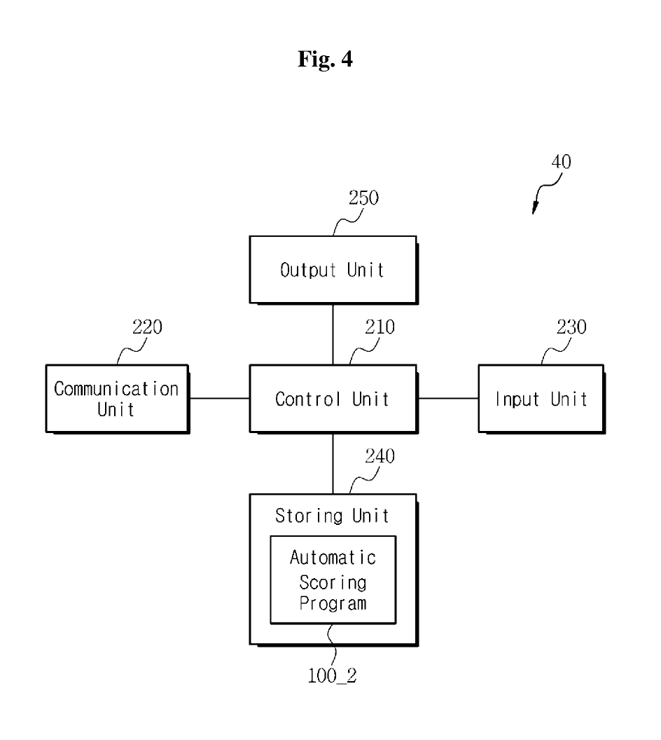

FIG. 4 is a diagram of a terminal device in which a program according to an automatic scoring method is installed according to an exemplary embodiment of the present disclosure.

Referring to FIG. 4, a terminal device 40 includes a control unit 210, a communication unit 220, an input unit 230, a storing unit 240, and an output unit 250. All or some components of the terminal device 40, such as the control unit 210, the communication unit 220, the input unit 230, the storing unit 240, and the output unit 250 are implemented by one or more processors and/or application-specific integrated circuits (ASICs). The terminal device 40 is a user information processing device capable of performing the automatic scoring method according to an exemplary embodiment of the present disclosure by installing and executing an automatic scoring program 100_2, and is any kinds of terminals capable of installing and executing a program. For example, the terminal device 40 is at least one among a tablet PC, a laptop computer, a PC, a smart phone, a PDA, a smart TV, a mobile communication terminal, etc.

The control unit 210 controls various operations and an operation related to an automatic scoring service execution of the terminal device 40. Specifically, when receiving a test request signal of a user, the control unit 210 controls to execute an application for test according to the received test request signal and display questions, etc. on a screen of the output unit 250. Accordingly, the control unit 210 receives and processes information with respect to answers of the questions, that is, scoring target data, through the input unit 230, and stores the processed scoring target data to the storing unit 240. The control unit 210 executes the automatic scoring program 100_2, and controls to score new scoring target data automatically. Further, the control unit 210 controls to display the final automatic scoring result information on the screen through the output unit 250 in order to notify the user.

The communication unit 220 receives and transmits data through the communication network 10, and the communication unit 220 receives and transmits data through various communication manners including a wired manner or a wireless manner. In addition, the communication unit 220 receives and transmits data using one or more communication manners, and for this, the communication unit 220 includes a plurality of communication modules of receiving and transmitting data according to a different communication manner.

The input unit 230 generates a user input signal corresponding to a request or information of the user according to the user's operation, and is implemented by various input devices which are currently commercialized or will be commercialized in future. For example, the input unit 230 is a general input device such as a keyboard, a mouse, a joystick, a touch screen, a touch pad, etc., and also includes a gesture input device for generating a specific input signal by sensing the user's motion. The input unit 230 transmits information input from the user to the control unit 210. That is, the input unit 230 receives answers with respect to the questions, that is, new scoring target data, from the examinee.

The storing unit 240 stores information needed for an operation of the terminal device 40, and specifically, stores information related to the automatic scoring service. Particularly, the storing unit 240 stores the automatic scoring program 100_2 programmed so that the automatic scoring method according to an exemplary embodiment of the present disclosure is performed. The storing unit 240 includes a magnetic media such as a hard disk, a floppy disk, or a magnetic tape, an optical media such as a compact disk read only memory (CD-ROM), or a digital video disk (DVD), a magneto-optical media such as a floptical disk, a ROM, a random access memory (RAM), and a flash memory.

The output unit 250 is a device provided so that an operation result or status of the terminal device 40 is notified to the user. For example, the output unit 250 includes a display unit of visually outputting through the screen, or a speaker of outputting an audible sound, etc. Specifically, the output unit 250 displays a screen related to the automatic scoring service driven in the terminal device 40, and display a screen for executing the automatic scoring service according to the user's request. Further, the output unit 250 displays the answers with respect to the questions input from the examinee, that is, the scoring target data, or display an automatic scoring score with respect to the scoring target data on the screen.

That is, the terminal device 40 executes the automatic scoring program 100_2, calculate the automatic scoring score of each of the evaluation regions using the scoring model of each of the evaluation regions with respect to the answers of the user input from the input unit 230, that is, the scoring target data, extract the abnormal evaluation region having the score in which the correlation disparity is beyond the predetermined range using the correlation model between the evaluation regions, calculate the generation probability of each of the scores of the abnormal evaluation region based on the automatic scoring scores of the remaining evaluation regions, and change the automatic scoring score of the abnormal evaluation region into the score having the highest probability. The terminal device 40 provides the finally calculated automatic scoring result for the user as described above.

Here, a program command recorded in the automatic scoring program 100_2 is specially designed and configured for the present disclosure, as understood by a person skilled in the field of computer software in view of the present disclosure.

The present disclosure relates to technology of automatically evaluating the answers of the user in one or more language regions including speaking, listening, writing, etc., and more particularly, when evaluating the one or more evaluation regions with respect to answers of the user, some embodiments of the present disclosure can more realistically model an implicit criterion with respect to the evaluation regions by generating a correlation model between the evaluation regions reflecting language educational characteristics, evaluation region characteristics, an examiner's answer evaluation characteristics, etc.

Further, some embodiments of the present disclosure can minimize an error with answer evaluation characteristics of the examiner, and increase reliability with respect to the evaluation result, when performing the automatic scoring through the scoring model of each of the evaluation regions by applying the correlation capable of occurring between the evaluation regions applying the correlation model between the generated evaluation regions.

Exemplary embodiments of the present disclosure disclosed in the drawings and specification are merely presented specific examples for better understanding, and are not intended to limit the spirit and scope of the claimed invention. Specific terms used in this disclosure and drawings are used for illustrative purposes and not to be considered as limitations of the present disclosure. Exemplary embodiments of the present disclosure have been described for the sake of brevity and clarity. In addition to exemplary embodiments disclosed herein, it will be obvious by those skilled in the art that various changes in form and details are made therein without departing from the spirit and scope of the claimed invention.

What is claimed is:

1. An automatic scoring apparatus, comprising:
an automatic scoring unit configured to
receive scoring target data,
automatically calculate a score per each of the evaluation regions with respect to the received scoring target data based on a scoring model; and
a score tuning unit configured to
tune the calculated score per each of the evaluation regions using a corresponding correlation model between the evaluation regions, and
calculate a final automatic scoring score.

2. The automatic scoring apparatus of claim 1, further comprising:
a scoring model generation unit configured to generate the corresponding scoring model per each of the evaluation regions through machine learning using previous scoring data obtained by evaluating at least one of the evaluation regions with respect to one or more answers and one or more evaluation qualities extracted from the one or more answers.

3. The automatic scoring apparatus of claim 2, further comprising:
a correlation model generation unit configured to generate the corresponding correlation model between the evaluation regions, the corresponding correlation model defining a probability in which each of scores between the at least one of the evaluation regions is generated based on the previous scoring data.

4. The automatic scoring apparatus of claim 1, wherein the score tuning unit is configured to
compare a score corresponding to one of the evaluation regions with other scores corresponding to remaining evaluation regions among the evaluation regions,
select an abnormal evaluation region in which a correlation disparity between the evaluation regions has a greater score than a predetermined range based on the comparison, and
tune the calculated score by adjusting a corresponding score of the selected abnormal evaluation region using the correlation model between the evaluation regions.

5. The automatic scoring apparatus of claim 4, wherein the score tuning unit is configured to
calculate generation probability of each of scores of the selected abnormal evaluation region with respect to each of scores of the remaining evaluation regions using the corresponding correlation model, and
change the corresponding score of the abnormal evaluation region into a score having the highest probability among the calculated generation probabilities of the scores of the selected abnormal evaluation region.

6. An automatic scoring method performed by an automatic scoring apparatus, the method comprising:
receiving scoring target data;
automatically calculating a score per each of one or more evaluation regions with respect to the received scoring target data based on a scoring model; and
tuning the calculated score per each of the evaluation regions using a corresponding correlation model between the evaluation regions.

7. The method of claim 6, wherein the tuning of the calculated score comprises:
comparing a score corresponding to one of the evaluation regions with other scores corresponding to remaining evaluation regions among the evaluation regions;
selecting an abnormal evaluation region in which a correlation disparity has a greater score than a predetermined range based on the comparison;

8. The method of claim 7, wherein the tuning of the calculated score further comprises:
tuning the calculated score by adjusting a corresponding score of the selected abnormal evaluation region using the correlation model between the evaluation regions.

9. The method of claim 7, wherein the tuning of the calculated score further comprises:
calculating generation probability of each of scores of the selected abnormal evaluation region with respect to each of scores of the remaining evaluation regions using the corresponding correlation model; and
changing the corresponding score of the abnormal evaluation region into a score having the highest probability among the calculated generation probabilities of the scores of the selected abnormal evaluation region.

10. The method of claim 6, further comprising:
generating the corresponding scoring model per each of the evaluation regions through machine learning using previous scoring data obtained by evaluating at least one of the evaluation regions with respect to one or more answers and one or more evaluation qualities extracted from the one or more answers.

11. The method of claim 8, further comprising:
generating the corresponding correlation model between the evaluation regions, the corresponding correlation model defining a probability in which each of scores between the at least one of the evaluation regions is generated based on the previous scoring data.

12. A non-transitory computer-readable recording medium recording a program for executing an automatic scoring method, the method comprising:
receiving scoring target data;
automatically calculating a score per each of one or more evaluation regions with respect to the received scoring target data based on the applied corresponding scoring model; and
tuning the calculated score per each of the evaluation regions using a corresponding correlation model between the evaluation regions.

13. The non-transitory computer-readable recording medium of claim 12, wherein the tuning of the calculated score comprises:
comparing a score corresponding to one of the evaluation regions with other scores corresponding to remaining evaluation regions among the evaluation regions;
selecting an abnormal evaluation region in which a correlation disparity has a greater score than a predetermined range based on the comparison.

14. The non-transitory computer-readable recording medium of claim 12, wherein the tuning of the calculated score further comprises:
tuning the calculated score by adjusting a corresponding score of the selected abnormal evaluation region using the correlation model between the evaluation regions.
